(19) United States
(12) Patent Application Publication
(10) Pub. No.: US 2001/0028037 A1
(43) Pub. Date: Oct. 11, 2001

(54) Hollow-beam aperture for charged-particle-beam optical systems and microlithography apparatus, andbeam-adjustment methods employing same

(76) Inventor: Shohei Suzuki, Tokyo (JP)

Correspondence Address: KLARQUIST SPARKMAN CAMPBELL, LEIGH & WHINSTON, LLP, One World Trade Center, Suite 1600, 121 S.W. Salmon Street, Portland, OR, 97204-2988, US

(21) Appl. No.: 09/766,129

(22) Filed: Jan. 19, 2001

(30) Foreign Application Priority Data
Jan. 21, 2000 (JP) 2000-012622

(51) Int. Cl. G21K 1/08; H01J 3/14; H01J 3/26; H01J 49/42

(52) U.S. Cl. 250/396 R

(57) ABSTRACT

Hollow-beam apertures and methods for using same are disclosed, especially for achieving alignment of the beam center with the center of the hollow-beam aperture. The hollow-beam apertures define beam-transmissive portions (e.g., through-holes) that form a hollow beam propagating downstream of the hollow-beam aperture. Also included is a relatively thick region that causes absorption of at least a portion of the incident beam and may also cause localized scattering of the beam. Absorption of charged particles generates an electrical current that can be measured. From such current measurements accompanying controlled displacement of the incident beam, a measurement of the lateral beam-intensity distribution can be obtained. I.e., the current typically is maximal whenever the beam center is aligned with the center of the hollow-beam aperture. Lateral beam adjustment can be achieved using an aligner (deflector assembly).

### FIELD OF THE INVENTION

This invention pertains to microlithography (projection-transfer of a pattern, defined by a reticle or mask, to a sensitive substrate using an energy beam). Microlithography is a key technology used in the fabrication of microelectronic devices such as semiconductor integrated circuits, displays, and the like. More specifically, the invention pertains to microlithography performed using a charged particle beam (e.g., electron beam or ion beam) and charged-particle-beam (CPB) optical systems used to perform this type of microlithography using a “hollow beam.” Even more specifically, the invention pertains to devices and methods for aligning hollow apertures used in CPB optical systems and for adjusting exposure dose obtained with CPB optical systems.

### BACKGROUND OF THE INVENTION

Charged-particle-beam (CPB) microlithography currently is under intensive development as a possible successor technology to optical microlithography. CPB microlithography offers prospects of greater resolution than optical microlithography for reasons essentially similar to reasons why electron microscopy generally yields greater resolution than optical microscopy. CPB microlithography apparatus utilize a charged particle beam (e.g., electron beam or ion beam) as an energy beam for making microlithographic exposures, rather than a beam of light (typically ultraviolet light) as used in optical microlithography.

In a propagating charged particle beam, individual charged particles tend to repel each other. This repulsion is termed a “Coulomb effect” and results in spreading of the beam in a “lateral” direction (i.e., a direction perpendicular to the propagation axis of the beam). The magnitude of the Coulomb effect is greater at higher beam current, and typically causes undesired phenomena such as beam “blur,” downstream shift of the focal position of the beam, and generation of one or more of the five Seidel aberrations in the plane of the projected image.

A conventional manner of reducing the Coulomb effect is to use a hollow beam. This approach is disclosed, for example, in Japan Kôkai Patent Document No. 11-297610. Basically, a beam as produced by the CPB source is passed through an annular “hollow-beam aperture” centered on the optical axis at a beam crossover. The hollow-beam aperture usually is an annular aperture defined by a plate of material that tends to scatter or absorb incident charged particles of the beam. Hence, the hollow-beam aperture is a “scattering-stencil” type or “absorbing-stencil” type, respectively.

When installing a stencil-type hollow-beam aperture, to obtain best performance, it is important that the center of the transverse distribution of incident beam current be aligned with the center (axis) of the hollow-beam aperture. This ideal situation is depicted in FIG. 7(A) in which the hollow-beam aperture 41 comprises an aperture plate 41p defining an annular aperture 41a. The beam as incident (from above in the figure) on the hollow-beam aperture 41 has a Gaussian distribution of beam current as indicated by the broken line 42. A corresponding hatched region denotes the “transmitted beam” 43 (i.e., portion of the incident beam current transmitted through the annular aperture 41a). As can be seen in FIG. 7(A), the transmitted beam 43 has a symmetrical distribution of beam current relative to the axis Ax of the annular aperture 41a. Unfortunately, despite complex alignment methods used in conventional CPB microlithography apparatus, this ideal condition is very difficult to achieve and consequently seldom is achieved.

Turning now to FIG. 7(B), if the center of the distribution of incident beam current is shifted laterally a distance Δr from the axis (center) Ax of the annular aperture 41a, then the transmitted beam 43 has an asymmetrical distribution of beam current relative to the axis Ax. In the situation shown in FIG. 7(B), aberrations caused by Coulomb effects generated by the asymmetrically distributed beam cause non-uniform beam blur and non-linear distortions at the transfer-image plane. As a result, the benefits that otherwise would be obtained from painstaking efforts to form a hollow beam are not realized.

Other misalignments also are possible. For example, FIG. 8(A) depicts a situation in which the center B of the inner diameter of the annular aperture 41a and the center C of the outer diameter of the annular aperture 41a are not coincident; i.e., the outer-diameter center C is shifted laterally relative to the inner-diameter center B. This condition actually produces less downstream asymmetry of the hollow beam than produced by a condition in which the center A of the incident beam is aligned with the outer-diameter center C but not with the inner-diameter center B (FIG. 8(B)). Hence, the condition depicted in FIG. 8(B) produces less increase in Coulomb effect. Accordingly, if axial alignment of the beam is to be performed, an adjustment in which the beam center A is aligned with the center B of the inner circle of the hollow aperture as shown in FIG. 8(A) is desirable over the situation shown in FIG. 8(B).

It is relatively easy to perform an alignment of the incident beam with a simple round aperture. In the latter instance, the magnitude of beam current generated by absorption of incident charged particles by the aperture plate is measured. Alignment of the center of the beam with the center of a simple round aperture is considered achieved whenever the measured current is at a minimum.

In contrast, with a scattering-stencil annular aperture, all (100%) of the charged particles of the incident beam are transmitted through the aperture; i.e., particles passing through the annular aperture are transmitted without scattering, and particles incident on the aperture plate are scattered as they pass through the aperture plate. Since no particles are absorbed by the aperture plate, no current is generated in the aperture plate, rendering current detection impossible. With an absorption-type of annular aperture, structural members (typically extensions of the aperture plate) must extend across the annular aperture to support the inner portion of the aperture plate. In other words, the inner and outer portions of the aperture plate are electrically continuous with each other. Electrical current generated by incidence of the charged particle beam with the inner portion is detected simultaneously with detection of electrical current generated by incidence of the charged particle beam with the outer portion. Any discrepancy in the center of the incident beam versus the center of the annular aperture has a complex relationship with the detected electrical current. Consequently, any lateral displacement of these centers relative to each other cannot be detected accurately by measuring electrical current in this conventional manner.

Another conventional approach for detecting positional alignment of the incident beam with an annular aperture involves detecting an image, of the beam crossover, at a location downstream from the annular aperture. Unfortunately, electrical energy routed to a lens (of the CPB optical system) to excite the lens must be re-set each time an image of a beam crossover is formed in a different specified location. Consequently, it is very difficult using this approach to monitor and align beam position during an exposure sequence.

### SUMMARY OF THE INVENTION

In view of the shortcomings of conventional apparatus and methods as summarized above, one object of the invention is to provide hollow-beam apertures that can be aligned easily with the center of an incident charged particle beam. Another object is to provide charged-particle-beam (CPB) optical systems and microlithography apparatus that include such a hollow-beam aperture. Yet another object is to provide beam-alignment and exposure-dose alignment methods involving use of such a hollow-beam aperture.

According to a first aspect of the invention, hollow-beam apertures are provided for use especially in CPB optical systems. An embodiment of a hollow-beam aperture comprises an aperture plate and defines an opening at least partially transmissive to charged particles of an incident charged particle beam. The opening is configured so as to form, from the incident charged particle beam, a hollow charged particle beam propagating downstream of the hollow-beam aperture. Hence, the opening is configured as a “substantially annular aperture.” The aperture plate comprises a first portion surrounded by a second portion. The first portion is configured to exhibit, to a degree greater than other portions of the hollow-beam aperture, at least one of forward scattering, backscattering, and absorption of incident charged particles of the charged particle beam. To achieve such results, the first portion can be thicker than the second portion. The thick portion desirably not only absorbs some of the incident charged particles but also scatters (forward scattering and/or backscattering) some of the incident charged particles. By measuring the current of absorbed and/or scattered particles of the beam, the relationship of the beam center with the center of the hollow-beam aperture can be ascertained. From a knowledge of this relationship, alignment of the beam center with the center of the hollow-beam aperture can be achieved. Such detection and alignment can be performed during a microlithographic exposure sequence.

As noted above, a hollow-beam aperture according to the invention desirably absorbs a portion of the incident charged particle beam. Such absorption can increase the temperature of the hollow-beam aperture by several tens to several hundreds of degrees. Such heating of the aperture tends to inhibit deposition of contaminants on the hollow-beam aperture that otherwise would accumulate charge and cause beam drift.

The hollow-beam aperture can be configured as a scattering-stencil aperture, wherein charged particles incident on the aperture plate experience scattering by the aperture plate, and charged particles incident on the opening experience essentially no scattering during passage through the hollow-beam aperture. In such a configuration, the opening can be defined as multiple through-holes collectively defining a substantially annular aperture extending through the aperture plate. The through-holes desirably surround the first portion.

A “scattering-stencil aperture” as used herein is not limited to a hollow-beam aperture in which 100% of the incident charged particle beam is transmitted. This term also encompasses hollow-beam apertures that absorb several percent to several tens of percent of the incident charged particle beam.

In another configuration, the first portion is situated in a center region of the aperture plate and absorbs at least a portion of the charged particle beam incident on the first portion. An axis of the CPB optical system passes concentrically through the center region, and the opening surrounds the center region.

In another embodiment, the hollow-beam aperture comprises an aperture plate and defines an opening at least partially transmissive to charged particles of an incident charged particle beam so as to form a hollow charged particle beam downstream of the hollow-beam aperture. A unit of electrically conductive material is attached to a portion of the aperture plate. The unit of electrically conductive material is configured to exhibit, to a degree greater than other portions of the hollow-beam aperture, at least one of forward scattering, backscattering, and absorption of incident charged particles of the charged particle beam. This hollow-beam aperture can be configured as a scattering-stencil aperture as defined above.

More specifically regarding this embodiment, the unit of electrically conductive material can be situated in a center region of the aperture plate and configured to absorb at least a portion of the charged particle beam incident on the unit of electrically conductive material. In this configuration, the opening surrounds the center region, and the unit of electrically conductive material desirably absorbs at least a portion of the charged particle beam incident on the unit the hollow-beam aperture.

In another embodiment, a first layer of an electrically insulating material is situated between the substrate and the unit of electrically conductive material. In this configuration, a wiring trace desirably is connected to the unit of electrically conductive material. The wiring trace is connectable to a detector that detects a current of charged particles absorbed by the unit and conducted by the wiring trace.

A second layer of an electrical insulating material can be applied over the wiring trace and the unit of electrically conductive material. In such a configuration, a layer of an electrically conductive material desirably is applied over the second layer of an electrical insulating material.

Any of these embodiments that include at least one unit of electrically conductive material can be configured in the context of a scattering-stencil reticle or an absorption-stencil reticle. In either configuration, the relationship between the unit of electrically conductive material and the center of the incident beam can be ascertained readily, allowing easy beam alignment (which can be performed during a microlithographic exposure). Also, any of these embodiments can include a surficial thin layer of electrically conductive material connectable to electrical ground. Of course, the surficial layer of electrically conductive material must be insulated from the wiring trace(s) and other separately conductive portions of the hollow-beam aperture. Hence, the beam current absorbed by the surficial conductive layer is not “mixed” with the detected beam current. The thin surficial conductive layer desirably is sufficiently thin to prevent any significant absorption by the layer of incident charged particles.

If the charged particle beam is an electron beam, the unit of conductive material desirably has a thickness of 1 μm or greater to absorb the incident electrons that are accelerated under the usual acceleration voltage of approximately 100 keV.

In another embodiment, multiple units of electrically conductive material are situated radially outward from the opening. This configuration further can comprise a first layer of an electrically insulating material situated between the substrate and the units of electrically conductive material. Respective wiring traces desirably are connected to the units of electrically conductive material. The wiring traces are connectable to a detector that detects respective currents of charged particles absorbed by the units and conducted by the respective wiring traces. This configuration further can comprise a second layer of an electrical insulating material applied over the wiring traces and the units of electrically conductive material. A layer of an electrically conductive material desirably is applied over the second layer of an electrical insulating material.

When using any of the hollow-beam apertures according to the invention for performing beam alignment, beam asymmetry typically is smallest whenever the center of the hollow-beam aperture (e.g., the center of the first portion or the center of unit of conductive material) is aligned with the center of the incident beam.

The unit(s) of conductive material are not limited to having a circular profile. Alternatively, the units can have any of various other profiles such as regular polygonal or annular. Further alternatively, each unit can be configured as a respective array of smaller units arranged to have, for example, a collective circular or polygonal profile. In any event, the “center” of the profile of a unit refers to the center of symmetry of the unit.

According to another aspect of the invention, CPB optical systems are provided that include any of the hollow-beam apertures according to the invention. These CPB optical systems desirably also include an aligner (deflector assembly) situated and configured to displace the charged particle beam laterally to produce a change in beam current received by the first portion.

According to another aspect of the invention, CPB microlithography systems are provided that comprise a CPB optical system according to the invention.

According to yet another aspect of the invention, methods are provided, in the context of performing CPB microlithography, for aligning the charged particle beam. In an embodiment of such a method, a hollow-beam aperture (such as any of the embodiments summarized above) is provided. The hollow-beam aperture is situated along an optical axis of the CPB microlithography apparatus. A current of charged particles absorbed or scattered by the first portion is measured, wherein the current is a function of the lateral position of the beam.

A detector electrode can be provided that is situated and configured to receive charged particles scattered by the first portion. The current, from charged particles received by the detector electrode, produced in the detector electrode is measured.

The method also can include scanning the charged particle beam, in two dimensions in a plane perpendicular to the optical axis, relative to the hollow-beam aperture. The current is measured during the scanning to yield a beam-intensity distribution of the beam at a crossover position. A source (e.g., electron gun or ion source) of the charged particle beam is regulated, according to the measured current, so as to produce a desired beam-intensity distribution. I.e., the detected beam current, following completion of beam alignment, typically is proportional to the beam dose generated by the source. Accordingly, the beam dose can be maintained at a constant value by detecting the beam current, as described above, and controlling the source to maintain the beam current at a constant value.

An aligner can be provided, situated and configured to displace the charged particle beam laterally to produce a change in beam current received by the first portion. An amount of electrical energy applied to the aligner to achieve a desired change in beam current received by the first portion can be adjusted as required to achieve beam alignment with the hollow-beam aperture. After adjusting the aligner, the source of the charged particle beam also can be adjusted so as to maintain a desired beam current as received by the first portion.

The foregoing and additional features and advantages of the invention will be more readily apparent from the following detailed description, which proceeds with reference to the accompanying drawings.

### BRIEF DESCRIPTION OF THE DRAWINGS

FIGS. 1(A) and 1(B) are schematic elevational and plan views, respectively, of a hollow-beam aperture according to a first representative embodiment. FIG. 1(A) also depicts an exemplary method for using this hollow-beam aperture to perform beam alignment.

FIGS. 2(A)-2(C) depict respective example configurations of hollow-beam apertures. In FIG. 2(A), the left-hand portion is an elevational section and the right-hand portion is a plan view of a first example. In FIG. 2(B), the left-hand portion is an elevational section along the line A-A in the right-hand portion, and the right-hand portion is a planar section along the line B-B in the left-hand portion. FIG. 2(C) is a planar section, similar to that of FIG. 2(B), of a second example.

FIG. 3 is a schematic elevational view of another representative embodiment of a hollow-beam aperture and an exemplary method for using the same to perform beam alignment.

FIG. 4 is a schematic elevational diagram of certain aspects of an electron-beam microlithography apparatus according to another representative embodiment.

FIG. 5 is a process flowchart for manufacturing a microelectronic device, wherein the process includes a microlithography method according to the invention.

FIG. 6 is a process flowchart for performing a microlithography method utilizing a CPB microlithography apparatus according to the invention.

FIG. 7(A) is a plot showing representative distributions of incident and transmitted beam currents in a situation in which the center of the incident beam is aligned with the center of the hollow-beam aperture.

FIG. 7(B) is a plot showing representative distributions of incident and transmitted beam currents in a situation in which the center of the incident beam is not aligned with the center of the hollow-beam aperture.

FIGS. 8(A)-8(B) are respective plots of representative beam-current distributions obtained when the center B of the inner diameter of the hollow-beam aperture and the center C of the outer diameter of the hollow-beam aperture, respectively, are laterally displaced relative to the center of the incident beam.

### Detailed Description

This invention is described below in the context of representative embodiments that are not intended to be limiting in any way. Also, the embodiments are described below in the context of using an electron beam as an exemplary charged particle beam. It will be understood that the general principles of the various embodiments can be applied with ready facility to use of an alternative charged particle beam, such as an ion beam.

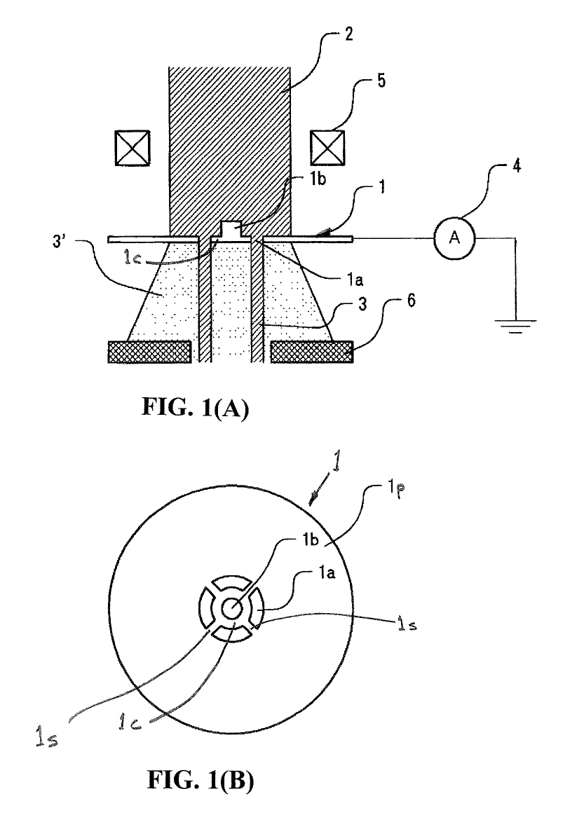

A first representative embodiment is depicted in FIGS. 1(A) and 1(B), depicting a scattering-stencil type of hollow-beam aperture 1, as well as a beam-alignment method utilizing such a hollow-beam aperture. The hollow-beam aperture 1 comprises an aperture plate 1p defining a pattern of through-holes 1a (FIG. 1(B)). The aperture plate 1p is made of an electrically conductive material, e.g., a silicon wafer. An exemplary thickness range for silicon is 0.5 to 2.0 μm, which provides adequate strength and rigidity to the aperture plate without excessively absorbing incident electrons. The through-holes 1a collectively define an annular aperture essentially surrounding a center portion 1c. The annular aperture and center portion 1c desirably are concentric. An incident electron beam 2 impinges on the hollow-beam aperture 1 from an upstream direction (FIG. 1(A)). As the beam 2 interacts with the hollow-beam aperture 1, a “transmitted portion” 3 of the beam passes through the through-holes 1a directly without scattering. Another portion, termed the “scattered portion” 3′ of the beam passes through the aperture plate 1p, surrounding the through-holes 1a, with scattering (indicated as a divergent beam in FIG. 1(A)). The aperture plate 1p is connected electrically to an ammeter 4 for measuring electrical current in the aperture plate 1p. An upstream deflector assembly (“aligner”) 5 is used for adjusting the position of the incident beam 2 laterally relative to the hollow-beam aperture 1. Downstream of the hollow-beam aperture 1 is a scattering aperture 6 serving to block downstream transmission of the scattered portion 3′ of the beam.

In the FIG.-1(B) configuration, the aperture plate 1p defines four identically shaped through-holes 1a arranged equilaterally and equi-angularly about the center portion 1c and collectively define an annular aperture having an inside diameter and an outside diameter. Each of the through-holes has a radial width in a dimensional range that takes into consideration the characteristics of the CPB-optical system, especially the relation between the beam semi-angle, defocus, and other aberrations. Not intending to be limiting, an exemplary inside diameter is 160 μm, and an exemplary outside diameter is 200 μm, yielding a radial width of 20 μm.

Support members 1s, that support the center portion 1c, extend across the annular aperture. An exemplary width (based on the foregoing example dimensions of the through-holes) of the support members is is 10 μm. The center portion 1c includes a relatively thick (compared to the thickness of the aperture plate 1p) portion 1b that is contiguous with the center portion 1c. For example, the thick portion 1b has a thickness in the range of 10 μm to 200 μm. Based on an exemplary aperture-plate thickness of 0.5 to 2.0 μm, an exemplary range of thickness difference between the aperture plate 1p and the thick portion 1b is 10 to 200 μm. An exemplary range of diameter of the thick portion 1b is 60 μm to 100 μm. The thick portion 1b desirably is concentric with the annular aperture collectively formed by the through-holes 1a.

As the incident electron beam 2 impinges on the hollow-beam aperture 1, the transmitted portion 3 is formed by passage of the beam through the through-holes 1a. The transmitted portion 3 defines a hollow beam that can be used for microlithographic exposure. The scattered portion 3′ is formed by passage of a respective portion of the incident beam 2 through the aperture plate 1p.

In the thick portion 1b, the incident beam 2 not only is scattered at a wide angle, but also is absorbed and reflected (backscattered). Absorption of incident electrons of the beam generates an electrical current that is detected by the ammeter 4. The incident beam 2 generally has a Gaussian or at least an axially symmetrical distribution in which the beam current in the center of the beam is stronger than the beam current at the periphery of the beam. As a result, whenever the center portion 1b is concentric with the annular aperture, the electrical current as detected by the ammeter 4 is at a maximum (and the beam asymmetry is at a minimum) whenever the center of the thick portion 1b is aligned axially with the center of the incident beam 2.

To obtain such alignment, the constituent deflectors of the aligner 5 are used. Specifically, energization of the constituent deflectors of the aligner 5 is adjusted until the electrical current detected by the ammeter 4 is at a maximum. As noted above, detection of maximum electrical current corresponds with achievement of alignment of the center of the hollow-beam aperture 1 with the incident beam 2. The scattered beam portion 3′ is absorbed by the scattering aperture 6 to prevent the scattered charged particles from participating in the microlithographic exposure.

Although the thick portion 1b is depicted having a circular profile, the depicted configuration is not intended to be limiting. The profile alternatively can be, e.g., polygonal or annular. Also, the thick portion 1b need not be single but rather can be configured as an array of smaller thick portions collectively forming the noted thick portion 1b.

If it is anticipated that a buildup of electrical charge will occur due to accumulation of oxidation products, it is desirable to coat the hollow-beam aperture 1 (specifically the aperture plate 1p) with a thin film (desirably 50 nm or less) of an electrically conductive material. The stated thinness of the film of electrically conductive material is sufficient to prevent, to a satisfactory degree, absorption of the incident charged particle beam. Also, it is not necessary to provide a layer of electrically insulating material between the aperture plate 1p and the conductive thin film. This is because, as noted above, the conductive thin film is configured so as to not absorb charged particles of the incident charged particle beam. In any event, the ammeter 4 is connected to electrically conductive material on the aperture plate 1p.

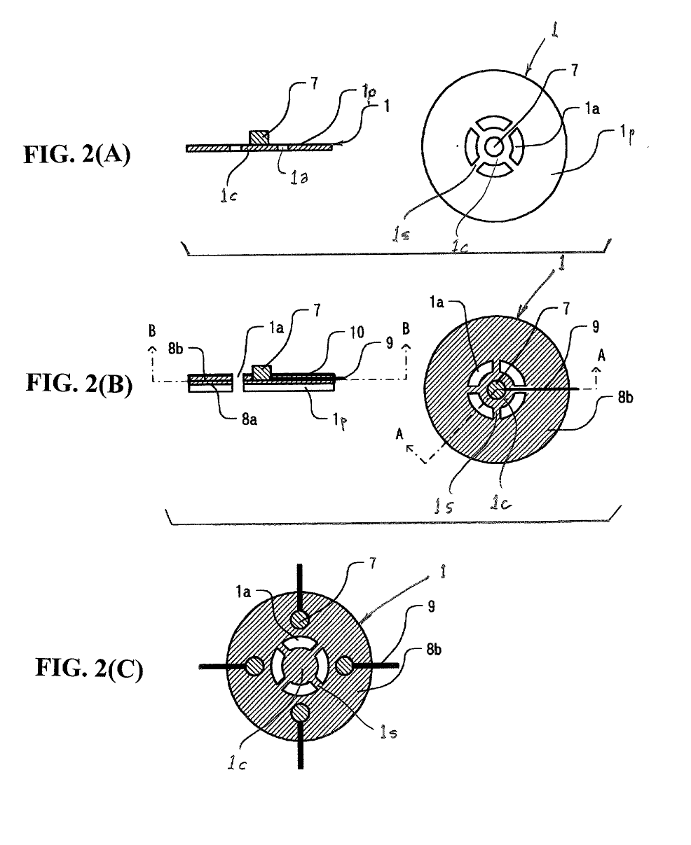

FIGS. 2(A)-2(C) depict respective example configurations of the hollow-beam aperture 1 that can be used with the embodiment shown in FIG. 1(A). In FIGS. 2(A)-2(C), components that are the same as respective components shown in FIGS. 1(A)-1(B) have the same respective reference numerals, and are not described further below. In FIGS. 2(A)-2(C), units of electrically conductive material are denoted by the reference numeral “7”, and respective films of electrically insulating material are denoted by the reference numerals 8a, 8b. Exemplary materials that can be used for forming the units 7 of conductive material are W, Au, Pt, Mo, or other heavy metal. An electrical wiring trace is denoted by “9”, and an electrically conductive thin film is denoted by “10”.

Turning first to FIG. 2(A), a respective exemplary hollow-beam aperture 1 is shown in which a unit 7 of electrically conductive material is disposed in the center portion 1c of the aperture plate 1p. The aperture plate 1p also is formed of an electrically conductive material. The position of the unit 7 of conductive material is concentric with the annular aperture collectively formed by the through-holes 1a. (Note that, in FIG. 2(A), the center of the annular aperture includes the unit 7 of electrically conductive material 7 formed on the center portion 1c of the aperture plate 1p. The aperture plate 1p is made of a different electrically conductive material than the unit 7. In FIG. 1(A), in contrast, the thick portion 1b and center portion 1c are made of the same conductive material used to form the aperture plate 1p.) In FIG. 2(A), the left-hand portion of the figure is an elevational section of the right-hand portion. The unit 7 of conductive material in FIG. 2(A) has a thickness (desirably 1 μm or greater) appropriate to absorb a substantial proportion of the charged particles incident on it. (A thickness of 1 μm will absorb incident electrons of a beam accelerated by an acceleration voltage of approximately 100 keV.) The beam current absorbed by the unit 7 of conductive material is conducted radially outward over the supports Is for measurement.

FIG. 2(B) shows an example configuration that can be applied to both a scattering-type and an absorption-type of stencil aperture used for forming a hollow beam. The left-hand portion of the figure is an elevational section along the line A-A of the right-hand portion of the figure, and the right-hand portion is a plan section along the line B-B of the left-hand portion. Specifically, the aperture plate 1p is formed of an electrically conductive material on which a thin insulating film 8a is formed on the upstream-facing surface of the aperture plate 1p. An exemplary material for the thin insulating film 8a is SiO₂, and an exemplary thickness is 100 to 500 nm. A unit 7 of an electrically conductive material is formed on the insulating film 8a in the center of the center portion 1c (concentrically with the annular aperture collectively defined by the through-holes 1a). The unit 7 functions as an “electrode” that absorbs at least a proportion of the charged particles incident on it and produces a corresponding current. An electrical wiring trace 9 extends from the unit 7 radially outward over a support member 1s for connection to the ammeter 4. Exemplary materials for forming the wiring trace 9 are Au, Al, Pt, and Cu, at a thickness range of 50 to several hundred nm, and a typical width of 10 μm. The film 8a and wiring trace 9 (but not the unit 7 of conductive material) are coated with a thin insulating film 8b. (The unit 7 of conductive material need not be coated because a charged particle beam does not pass easily through an insulating material.) An exemplary material for the thin insulating film 8b is SiO2, at an exemplary thickness range of 100 to 500 nm.

Finally, the edge surfaces of the insulating film 8a and the entire surface of the insulating film 8b are coated with an electrically conductive thin film 10. A desirable material for the conductive thin film 10 is Al, at an exemplary thickness of several tens of nm. The conductive thin film 10 is used to prevent buildup of electrical charge on the hollow-beam aperture 1 during use. The conductive thin film 10 also is applied to the edges of the through-holes 1a to prevent charge-accumulation in those locations. The conductive thin film 10 is connected to electrical ground. With such a configuration, any current generated by accumulation of electrical charge on the hollow-beam aperture 1 is absorbed by the hollow-beam aperture 1 itself without being conducted to the wiring 9. Film-forming techniques used to make the hollow-beam aperture 1 of FIG. 2(B) are well-known in the art and are not described herein.

If the wiring 9 is sufficiently thin (e.g., 50 nm or less), then the proportion of the incident beam 2 absorbed by the wiring 9 is acceptably small compared to the proportion of the incident beam 2 absorbed by the unit 7 of conductive material. Accordingly, the detected beam current can be regarded as arising essentially only by absorption of incident charged particles by the unit 7 of conductive material, thereby facilitating accurate beam alignments.

The configuration of the FIG.-2(B) example includes the insulating film 8b. However, the insulating film 8b is not required. In an alternative configuration, the conductive thin film 10 is layered over the insulating film 8a following the formation of the unit 7 of conductive material on the insulating film 8a. This alternative configuration prevents charge-accumulation on the hollow-beam aperture 1 while still allowing extraction of the electrical current from the hollow-beam aperture 1(the conductive thin film 10, which inhibits charge accumulation by shunting charges to ground, is insulated from the aperture plate 1p by the insulating layer 8a). In such a configuration, it is highly desirable that the conductive thin film 10 be very thin (50 nm or less). Also, it is desirable that this alternative configuration be structured such that the incident beam 2 does not strike the edge surfaces of the insulating film 8a to prevent charge accumulation that could adversely affect beam propagation.

The example of FIG. 2(C) includes multiple units 7 of conductive material, each serving as a respective “electrode.” Four units 7 are shown. The units 7 are not situated in the center portion 1c but rather are situated in four respective places around the periphery of the annular aperture defined by the through-holes 1a. A respective wiring trace 9 is connected to each unit 7 to allow respective electrical currents in each unit 7 to be detected individually. The elevational section of the configuration of FIG. 2(C) has the same basic structure as shown in the left-hand portion of FIG. 2(B), wherein FIG. 2(C) depicts a plan section similar to the plan section along the line B-B in FIG. 2(B).

In FIG. 2(C), the units 7 of conductive material are disposed at equi-angular intervals on a circle concentric with the annular aperture collectively defined by the through-holes 1a. The units 7 desirably are formed on a layer 8a of insulating film applied to the aperture plate 1p. Respective wiring traces 9 are formed so as to contact the respective units 7 electrically. As in the configuration of FIG. 2(B), the units 7 of conductive material are formed sufficiently thick (desirably 1 nm or more) to achieve adequate absorption of the incident beam 2. Also, the wiring 9 is formed sufficiently thin (desirably 50 nm or less) so as to exhibit as low an absorption of the incident beam 2 as possible. An insulating film 8b is applied to provide good electrical isolation of the units 7 from each other, thereby allowing respective currents from the units to be measured independently. A thin (desirably 50 nm or less) coating of a conductive film 10 is applied last to prevent buildup of electrical charge on the hollow-beam aperture during use. To such end, the thin conductive film 10 is connected to electrical ground to which charges are shunted. As a result, no “mixing” occurs of the charges absorbed by the conductive thin film 10 and charges absorbed by the units 7. Also, the thinness of the conductive film 10 prevents significant absorption of charged particles by the film 10.

Although the units 7 of conductive material are depicted having a circular profile, the depicted configuration is not intended to be limiting. The profile alternatively can be, e.g., polygonal or annular. Also, each unit 7 need not be single but rather can be configured as an array of smaller units collectively forming the respective unit 7.

Further with respect to the FIG.-2(C) configuration, the respective electrical current readings obtained from the individual units 7 of conductive material are equal whenever the center of the annular aperture and the center of the incident beam are aligned with each other. Whenever these centers are not co-aligned, the respective current readings obtained from individual units 7 located closer to the center of the incident electron beam are higher than respective current readings obtained from units 7 located farther from the center of the beam. These differential readings allow the center of the incident beam to be aligned readily with the center of the annular aperture. I.e., after obtaining the individual readings, if the readings are not equal to each other, respective energizations of the constituent deflectors of the aligner 5 are changed as required to achieve alignment.

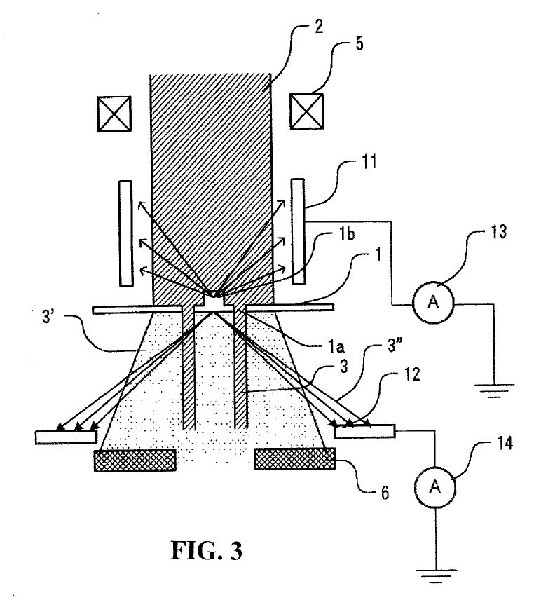

In the alignment methods described above, information concerning the position of the incident beam is obtained by detecting absorbed beam current. Alternatively, similar results can be obtained by detecting reflected (backscattered) electrons or electrons scattered at wide angles. A representative embodiment utilizing this approach is depicted in FIG. 3. In FIG. 3, the reference numeral 3″ denotes electrons (from the incident beam 2) scattered at a wide angle from the thick portion 1b. Items 11 and 12 are respective electrodes used for collecting and detecting scattered electrons. The electrode 11 is shown having a cylindrical configuration, and the electrode 12 has an annular configuration. Items 13 and 14 denote respective ammeters connected to the electrodes 11, 12. The hollow-beam aperture 1 in the FIG.-3 embodiment is similar to the hollow-beam aperture of FIGS. 1(A)-1(B), and further description of the hollow-beam aperture 1 is not provided below.

In FIG. 3, some of the electrons in the incident beam 2 impinge on the thick portion 1b and are backscattered toward the electrode 11. Some of the backscattered electrons are absorbed by the electrode 11, and the resulting electrical current generated in the electrode 11 is measured by the ammeter 13. In accordance with the principle discussed above with respect to FIGS. 1(A)-1(B), the quantity of backscattered electrons is greatest whenever the center of the thick portion 1b is aligned with the center of the incident beam 2. Hence, the center of the annular aperture collectively defined by the through holes 1a and the center of the incident beam can be aligned by selectively energizing the constituent deflectors of the aligner 5 to displace the incident beam 2 an appropriate distance in an appropriate lateral direction. The aligner 5 is adjusted in this manner until the current as read by the ammeter 13 is at a maximum.

Furthermore, electrons 3″ scattered at a wide angle by the thick portion 1b are absorbed by the electrode 12, and the resulting electrical current generated in the electrode 12 is measured by the ammeter 14. For reasons as discussed above, the quantity of widely scattered electrons 3″ is greatest whenever the center of the thick portion 1b is aligned with the center of the incident beam 2. Hence, the center of the annular aperture collectively defined by the through-holes 1a and the center of the incident beam 2 can be aligned by selectively energizing the constituent deflectors of the aligner 5 to displace the incident beam 2 an appropriate distance in an appropriate lateral direction. The aligner 5 is adjusted in this manner until the current as read by the ammeter 14 is at a maximum.

In FIG. 3, the electrode 11 is cylindrical, and the electrode 12 is planar and annular in shape. Alternatively, it is possible to split the single cylindrical electrode 11 and the annular electrode 12 into respective sets of electrode segments each connected to a respective ammeter. With such a configuration, the center of the annular aperture and the center of the incident beam 2 can be aligned in a manner similar to that described above, except that individual current readings are obtained from the respective ammeters connected to the electrode segments (see FIG. 2(C)).

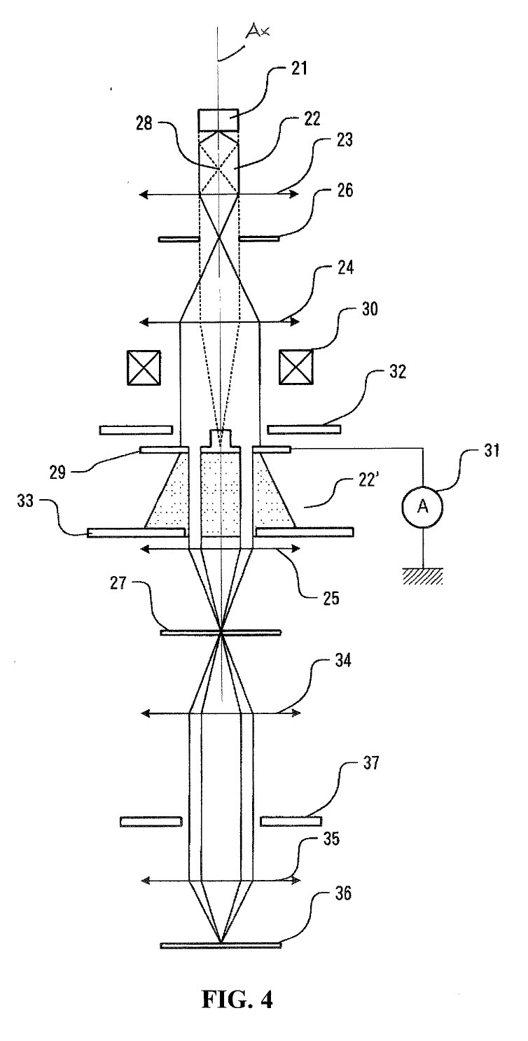

FIG. 4 is an schematic elevational diagram of a representative electronoptical system, according to the invention, as used in CPB microlithography apparatus utilizing an electron beam as an exemplary charged particle beam. The components in the FIG.-4 system are arranged along an optical axis Ax. The FIG.-4 system includes a hollow-beam aperture such as any of the embodiments described above. An electron beam 22 is generated by an electron-beam source 21s situated at the extreme upstream end of the apparatus. The electron beam 22 forms a crossover 28 and passes through first, second, and third illumination lenses 23, 24, 25, respectively. Downstream of the second illumination lens 24 is an aligner 30 as described above. Between the first and second illumination lenses 23, 24 is a beam-shaping aperture 26. Between the second and third illumination lenses 24, 25 are a current-absorbing aperture 32, a hollow-beam aperture 29 as described above, and a scattered-electron-absorbing aperture 33. Downstream of the third illumination lens 25 is a reticle 27 that defines the pattern to be transferred to a substrate 36 (e.g., semiconductor wafer). The hollow-beam aperture 29 is connected to an ammeter 31 as described above in connection with FIG. 1(A). The portion of the FIG.-4 system located between the source 21 and the reticle 27 is termed the “illumination-optical system.” Downstream of the reticle 27 are first and second projection lenses 34, 35 and a contrast aperture 37. The portion of the FIG.-4 system located between the reticle 27 and the substrate 36 is termed the “projection-optical system.”

The electron beam 22 emitted from the electron-beam source 21 passes through the first illumination lens 23 and is shaped by the beam-shaping aperture 26 as required to illuminate a desired exposure unit on the reticle 27. An image of the beam-shaping aperture 26 is focused on the reticle 27 by the second and third illumination lenses 24, 25, respectively. An image of the crossover 28 is focused on the hollow-beam aperture 29 by the first and second illumination lenses 23, 24, respectively.

The aligner 30 comprises multiple deflectors that are operable to displace the electron beam 22 two-dimensionally in directions perpendicular to the optical axis Ax. The aligner 30 thus establishes beam position such that the electrical current detected by the ammeter 31 is at a maximum, at which reading the axis of the electron beam 22 is aligned with the center of the inner diameter of the hollow-beam aperture 29, as described above.

The current-absorbing aperture 32 is situated just upstream of the hollow-beam aperture 29 to block scattered electrons propagating at the edges of the beam before the beam is incident on the hollow-beam aperture 29. This narrows the distribution of beam current at a respective crossover and thus reduces the thermal load on the hollow-beam aperture 29 and on the scattered-electron-absorbing aperture 33. The portion 22′ of the electron beam that is scattered by passage through the hollow-beam aperture 29 is absorbed by the scattered-electron-absorbing aperture 33.

The beam 22 passing through the annular aperture defined by the hollow-beam aperture 29 is focused on the reticle 27 by the third illumination lens 25. In this case, as a result of the accurate axial alignment achieved by the aligner 30, the angular distribution of beam-current density on the reticle 27 is that of a hollow beam with good axial symmetry. The respective pattern portion defined by the illuminated portion of the reticle 27 is projected onto the surface of the substrate 36 by the projection lenses 34, 35. As noted above, the projected beam has a hollow profile with a large aperture angle. Consequently, the Coulomb effect at the substrate 36 is reduced substantially, resulting in substantially reduced fluctuation of the focal point of the beam at the substrate 36 (fluctuation is reduced to no more than a few microns). Also, among the five Seidel aberrations, blur is reduced to at most several tens of nanometers, and distortion is reduced to no more than a few nanometers.

Furthermore, in an apparatus as shown in FIG. 4, whenever microlithographic exposure is initiated after completing beam alignment, the beam dose used for the projection transfer of the pattern can be maintained at a constant value by performing feed-back control of the temperature and electrode voltage of the source 21. Consequently, the current reading obtained by the ammeter 31 can be maintained constant.

A hollow-beam aperture and current-detection system as described above is a convenient tool for adjusting the electron-beam source 21. In an example, it is assumed that the optical axis Ax is the Z-axis of the system. The two-dimensional (X- and Y-dimensions) distribution of beam intensity at the crossover position can be measured by scanning the electron beam 22 two-dimensionally in the X-Y plane using the aligner 30. Meanwhile, the beam current is monitored using the ammeter 31. Using this scheme, the respective mechanical position and operating voltage of the source 21 and of deflector electrodes (not shown) can be adjusted based on the detected two-dimensional distribution of beam current.

In the configuration shown in FIG. 4, the hollow-beam aperture 29 is situated at the axial position of the crossover 28. Alternatively, the hollow-beam aperture 29 can be placed at an axial location that is conjugate to the crossover 28. In this alternative configuration, the beam-shaping aperture 26 also functions as a scattered-electron-absorbing aperture.

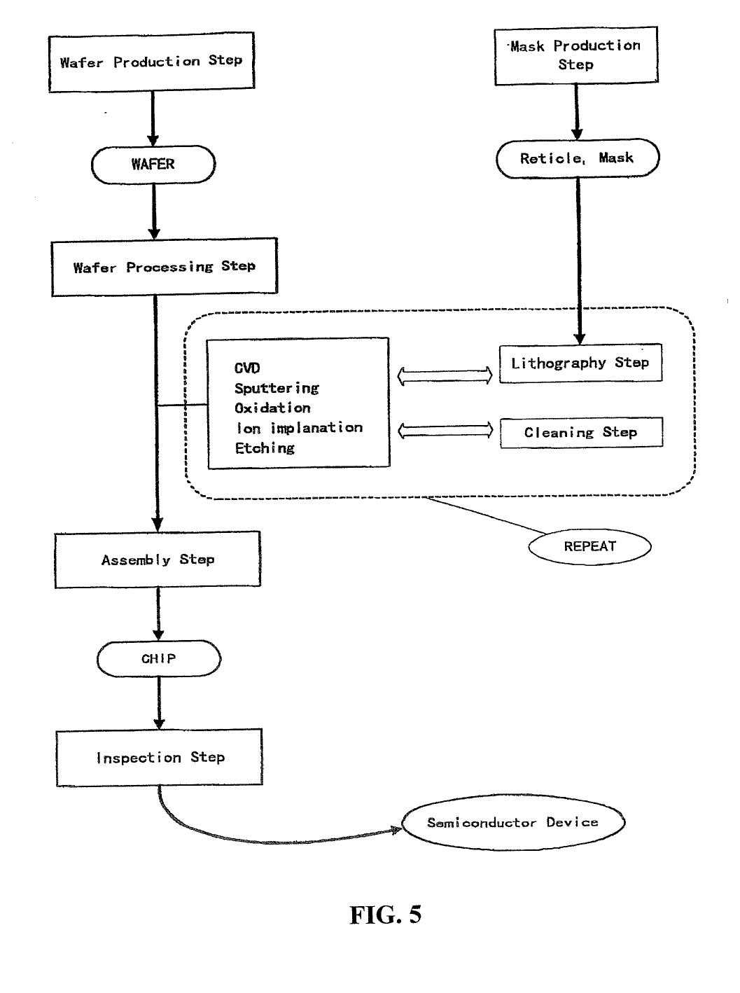

FIG. 5 is a flowchart of an exemplary microelectronic-fabrication method to which apparatus and methods according to the invention can be applied readily. The fabrication method generally comprises the main steps of wafer (substrate) production (wafer preparation), wafer processing, device assembly, and device inspection. Each step usually comprises several sub-steps.

Among the main steps, wafer processing is key to achieving the smallest feature sizes (critical dimensions) and best inter-layer registration. In the wafer-processing step, multiple circuit patterns are layered successively atop one another on the wafer, forming multiple chips destined to be memory chips or main processing units (MPUs), for example. The formation of each layer typically involves multiple sub-steps. Usually, many operative microelectronic devices are produced on each wafer.

Typical wafer-processing steps include: (1) thin-film formation (by, e.g., sputtering or CVD) involving formation of a dielectric layer for electrical insulation or a metal layer for connecting wires or electrodes; (2) oxidation step to oxidize the substrate or the thin-film layer previously formed; (3) microlithography to form a resist pattern for selective processing of the thin film or the substrate itself; (4) etching or analogous step (e.g., dry etching) to etch the thin film or substrate according to the resist pattern; (5) doping as required to implant ions or impurities into the thin film or substrate according to the resist pattern; (6) resist stripping to remove the remaining resist from the wafer; and (7) wafer inspection. Wafer processing is repeated as required (typically many times) to fabricate the desired semiconductor chips on the wafer.

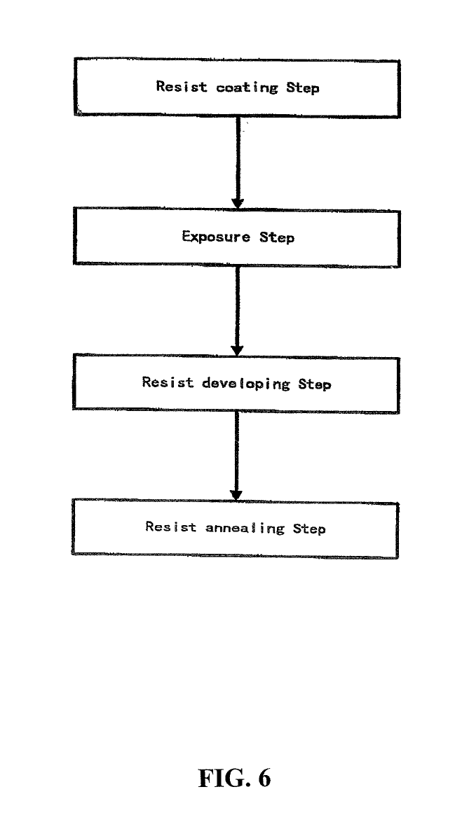

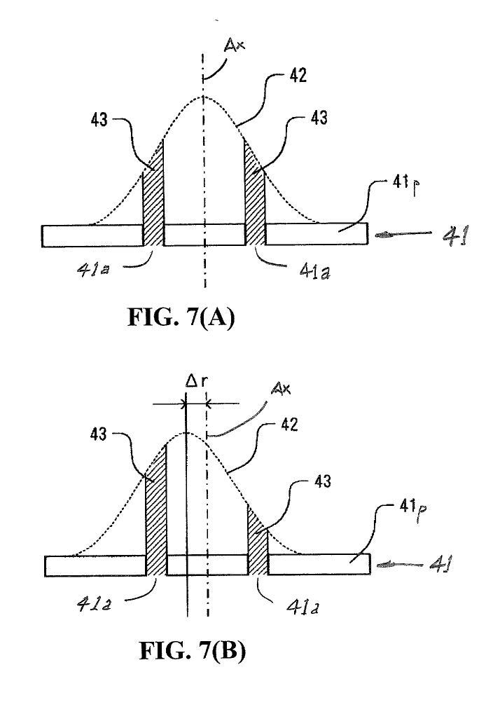

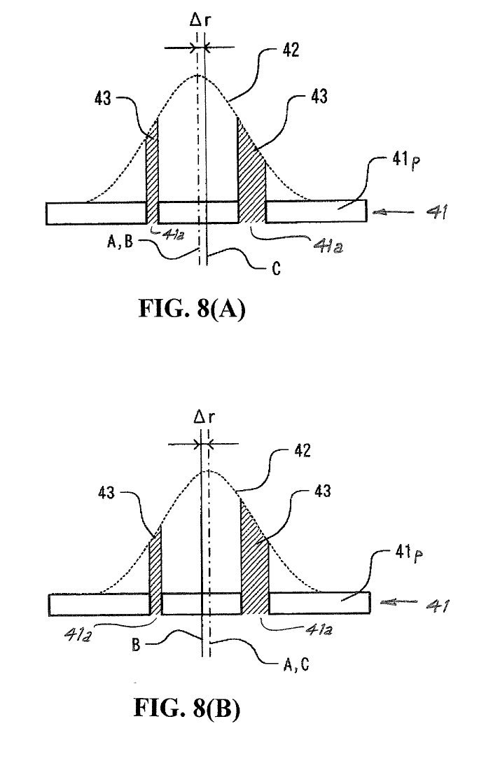

FIG. 6 provides a flowchart of typical steps performed in microlithography, which is a principal step in wafer processing. The microlithography step typically includes: (1) resist-application step, wherein a suitable resist is coated on the wafer substrate (which can include a circuit element formed in a previous wafer-processing step); (2) exposure step, in which the wafer is exposed and imprinted with the desired pattern; (3) development step, to develop the exposed resist to produce the imprinted image; and (4) optional resist-annealing step, to stabilize and enhance the durability of the resist pattern.

The process steps summarized above are all well known and are not described further herein.

Methods and apparatus according to the invention can be applied to a microelectronic-fabrication process, as summarized above, to provide substantially improved accuracy and resolution of pattern transfer, especially by reducing blur and other imaging aberrations.

Whereas the invention has been described in connection with multiple representative embodiments, it will be understood that the invention is not limited to those embodiments. On the contrary, the invention is intended to encompass all modifications, alternatives, and equivalents as may be included within the spirit and scope of the invention, as defined by the appended claims.

What is claimed is:

1. In a charged-particle-beam (CPB) optical system, a hollow-beam aperture, comprising an aperture plate and defining an opening at least partially transmissive to charged particles of an incident charged particle beam and configured so as to form, from the incident charged particle beam, a hollow charged particle beam propagating downstream of the hollow-beam aperture, the aperture plate comprising a first portion surrounded by a second portion, the first portion being configured to exhibit, to a degree greater than other portions of the hollow-beam aperture, at least one of forward scattering, backscattering, and absorption of incident charged particles of the charged particle beam.

2. The hollow-beam aperture of claim 1, wherein the first portion is thicker than the second portion.

3. The hollow-beam aperture of claim 1, configured as a scattering-stencil aperture, wherein charged particles incident on the aperture plate experience scattering by the aperture plate and charged particles incident on the opening experience essentially no scattering during passage through the hollow-beam aperture.

4. The hollow-beam aperture of claim 3, wherein:
the opening is defined as multiple through-holes collectively defining a substantially annular aperture extending through the aperture plate; and
the through-holes surround the first portion.

5. The hollow-beam aperture of claim 1, wherein:
the first portion is situated in a center region of the aperture plate and absorbs at least a portion of the charged particle beam incident on the first portion;
an axis of the CPB optical system passes concentrically through the center region; and
the opening surrounds the center region.

6. A CPB optical system, comprising the hollow-beam aperture of claim 1.

7. The CPB optical system of claim 6, further comprising an aligner situated and configured to displace the charged particle beam laterally to produce a change in beam current received by the first portion.

8. A CPB microlithography system, comprising the CPB optical system of claim 6.

9. In a charged-particle-beam (CPB) optical system, a hollow-beam aperture, comprising an aperture plate and defining an opening at least partially transmissive to charged particles of an incident charged particle beam so as to form a hollow charged particle beam downstream of the hollow-beam aperture, and a unit of electrically conductive material attached to a portion of the aperture plate, the unit of electrically conductive material being configured to exhibit, to a degree greater than other portions of the hollow-beam aperture, at least one of forward scattering, backscattering, and absorption of incident charged particles of the charged particle beam.

10. The hollow-beam aperture of claim 9, configured as a scattering-stencil aperture, wherein charged particles incident on the aperture plate experience scattering by the aperture plate and charged particles incident on the opening experience essentially no scattering during passage through the hollow-beam aperture.

11. The hollow-beam aperture of claim 10, wherein:
the opening is defined as multiple through-holes collectively defining a substantially annular aperture extending through the aperture plate; and
the through-holes surround the unit of electrically conductive material.

12. The hollow-beam aperture of claim 9, wherein:
the unit of electrically conductive material is situated in a center region of the aperture plate and absorbs at least a portion of the charged particle beam incident on the unit of electrically conductive material; and
the opening surrounds the center region.

13. The hollow-beam aperture of claim 9, wherein the unit of electrically conductive material absorbs at least a portion of the charged particle beam incident on the unit, the hollow-beam aperture further comprising:
a first layer of an electrically insulating material situated between the substrate and the unit of electrically conductive material; and
a wiring trace connected to the unit of electrically conductive material, the wiring trace being connectable to a detector that detects a current of charged particles absorbed by the unit and conducted by the wiring trace.

14. The hollow-beam aperture of claim 13, further comprising:
a second layer of an electrical insulating material applied over the wiring trace and the unit of electrically conductive material; and
a layer of an electrically conductive material applied over the second layer of an electrical insulating material.

15. The hollow-beam aperture of claim 9, further comprising a wiring trace connected to the unit of electrically conductive material, the wiring trace being connectable to a detector that detects a current of charged particles absorbed by the unit and conducted by the wiring trace.

16. The hollow-beam aperture of claim 9, further comprising a surficial layer of electrically conductive material connectable to electrical ground.

17. The hollow-beam aperture of claim 9, comprising multiple units of electrically conductive material situated radially outward from the opening.

18. The hollow-beam aperture of claim 17, further comprising:
a first layer of an electrically insulating material situated between the substrate and the units of electrically conductive material; and
respective wiring traces connected to the units of electrically conductive material, the wiring traces being connectable to a detector that detects respective currents of charged particles absorbed by the units and conducted by the respective wiring traces.

19. The hollow-beam aperture of claim 18, further comprising:
a second layer of an electrical insulating material applied over the wiring traces and the units of electrically conductive material; and
a layer of an electrically conductive material applied over the second layer of an electrical insulating material.

20. A CPB optical system, comprising the hollow-beam aperture of claim 9.

21. The CPB optical system of claim 20, further comprising an aligner situated and configured to displace the charged particle beam laterally to produce a change in beam current received by the first portion.

22. A CPB microlithography system, comprising the CPB optical system of claim 21.

23. In a method for performing charged-particle-beam (CPB) microlithography using a CPB microlithography apparatus in which a hollow charged particle beam is used to project an image of a pattern, defined by a reticle, onto a sensitive substrate, a method for aligning the charged particle beam, comprising:
(a) providing a hollow-beam aperture as recited in claim 1;
(b) situating the hollow-beam aperture along an optical axis of the CPB microlithography apparatus; and
(c) measuring a current of charged particles absorbed or scattered by the first portion, the current being a function of a lateral position of the charged particle beam.

24. The method of claim 23, wherein step (c) comprises:
providing a detector electrode situated and configured to receive charged particles scattered by the first portion; and
measuring a current produced in the detector electrode from charged particles received by the detector electrode.

25. The method of claim 23, wherein:
step (c) further comprises scanning the charged particle beam, in two dimensions in a plane perpendicular to the optical axis, relative to the hollow-beam aperture;
the current is measured during the scanning to yield a beam-intensity distribution of the beam at a crossover position; and
regulating a source of the charged particle beam so as to produce a desired beam-intensity distribution.

26. The method of claim 23, wherein step (c) comprises measuring a current produced in the first portion from absorption of charged particles by the first portion.

27. The method of claim 23, further comprising:
providing an aligner situated and configured to displace the charged particle beam laterally to produce a change in beam current received by the first portion; and
adjusting an amount of electrical energy applied to the aligner to achieve a desired change in beam current received by the first portion.

28. The method of claim 27, further comprising the step, after adjusting the aligner, of regulating a source of the charged particle beam so as to maintain a desired beam current as received by the first portion.

29. In a method for performing charged-particle-beam (CPB) microlithography using a CPB microlithography apparatus in which a hollow charged particle beam is used to project an image of a pattern, defined by a reticle, onto a sensitive substrate, a method for aligning the charged particle beam, comprising:
(a) providing a hollow-beam aperture as recited in claim 9;
(b) situating the hollow-beam aperture along an optical axis of the CPB microlithography apparatus; and
(c) measuring a current of charged particles absorbed or scattered by the unit of electrically conductive material, the current being a function of a lateral position of the charged particle beam.

30. The method of claim 29, wherein step (c) comprises:
providing a detector electrode situated and configured to receive charged particles scattered by the unit of electrically conductive material; and
measuring a current produced in the detector electrode from charged particles received by the detector electrode.

31. The method of claim 30, wherein:
step (c) further comprises scanning the charged particle beam, in two dimensions in a plane perpendicular to the optical axis, relative to the hollow-beam aperture;
the current is measured during the scanning to yield a beam-intensity distribution of the beam at a crossover position; and
regulating a source of the charged particle beam so as to produce a desired beam-intensity distribution.

32. The method of claim 29, wherein step (c) comprises measuring a current produced in the unit of electrically conductive material from absorption of charged particles by the unit.

33. The method of claim 29, further comprising:
providing an aligner situated and configured to displace the charged particle beam laterally to produce a change in beam current received by the unit of electrically conductive material; and
adjusting an amount of electrical energy applied to the aligner to achieve a desired change in beam current received by the unit.

34. The method of claim 33, further comprising the step, after adjusting the aligner, of regulating a source of the charged particle beam so as to maintain a desired beam current as received by the unit.

35. A process for manufacturing a microelectronic device, comprising the steps of:
(a) preparing a wafer;
(b) processing the wafer; and
(c) assembling devices formed on the wafer during steps (a) and (b), wherein step (b) comprises the steps of (i) applying a resist to the wafer; (ii) exposing the resist; (iii) developing the resist; and step (ii) comprises providing a CPB microlithography apparatus as recited in claim 8; and using the CPB microlithography apparatus to expose the resist with the pattern defined on the reticle.

36. A process for manufacturing a microelectronic device, comprising the steps of:
(a) preparing a wafer;
(b) processing the wafer; and
(c) assembling devices formed on the wafer during steps (a) and (b), wherein step (b) comprises the steps of (i) applying a resist to the wafer; (ii) exposing the resist; (iii) developing the resist; and step (ii) comprises providing a CPB microlithography apparatus as recited in claim 22; and using the CPB microlithography apparatus to expose the resist with the pattern defined on the reticle.

37. A microelectronic device produced by the method of claim 35.

38. A microelectronic device produced by the method of claim 36.
